(19) United States
(12) Patent Application Publication
(10) Pub. No.: US 2025/0172252 A1
(43) Pub. Date: May 29, 2025

(54) SYSTEMS AND METHODS FOR MANAGEMENT OF A WATER DISTRIBUTION SYSTEM

(71) Applicant: McCord Development Inc., Houston, TX (US)

(72) Inventors: Ashwin Chandran, Spring, TX (US); Frederick R McCord, JR., Houston, TX (US)

(73) Assignee: McCord Development Inc., Houston, TX (US)

(21) Appl. No.: 18/962,615

(22) Filed: Nov. 27, 2024

Related U.S. Application Data
(60) Provisional application No. 63/602,825, filed on Nov. 27, 2023.

(51) Int. Cl. F17D 3/01

(52) U.S. Cl. CPC F17D 3/01

(57) ABSTRACT

A water distribution system and a method of managing the water distribution system that includes detecting operational parameters of components of the water distribution system using sensors. The method also includes communicating the detected operational parameters to a management system comprising a processor. The method also includes processing the detected operational parameters using the management system by weighting the operational parameters based on at least one criterion to determine a single metric representing the operational status of the water distribution system. The method also includes displaying, using the management system, the single metric as a graphical image in a graphical user interface that allows a user to select the graphical image to display information relating to the operational parameters determining the single metric.

### BACKGROUND

A system for distributing a supply of water is made of an interconnected series of components between a water head and consumers, along with control devices such as valves and pumps. For example, the water head may supply water to a water treatment plant for treating the water to become drinking water. The drinking water may then be stored in a storage tank such as a water tower before being distributed to consumers. The water is typically treated by a water treatment system prior to distribution to comply with legal, regulatory, and consumer requirements relating to the quality and content of the distributed water. For example, some legal or regulatory requirements may relate to the maximum content of certain chemicals or materials within the water. Customer requirements may also be related to the desirable taste, smell, and appearance of the water that is distributed to consumer who are served by the water distribution system.

A water distribution system may cover a large geographic area. Leaks or blockages within the system may result in a reduced level of service provided to consumers and loss of valuable water resources. In some cases, undesirable chemicals or contaminants could be introduced to the water distribution system at intermediate locations within the water distribution system from outside the water mains and sub-mains of the system. The water mains that distribute water within the water distribution system are also typically located underground and are therefore difficult to access or monitor. Further, depending on the size of the water distribution system and the number of water mains and sub-mains, there may be hundreds if not thousands of components that need to be monitored to ensure the water is being delivered properly.

Such a system can be subject to numerous anomalies. For example, one type of anomaly includes hydraulic anomalies that may include leaks, blockages, water theft, hydrant use, data/communication system malfunction, meter malfunction, valve malfunction, abnormal variation of pressure, fast drop of the water level of a reservoir, and incoherent mass balance of storage. Another type of anomaly includes operation anomalies that occur when an element in the system is in an incorrect state, for example a valve in an opening state different to that stored in an information system. These anomalies, especially leaks, can dramatically reduce the performance of the water distribution system. For example, leaks in the pipes are the cause of the loss of a significant part of the water between the water head and consumers and can also be the cause or the result of structural damages. Due to the costs of potable water, the scarcity of fresh water supplies, and the increasing costs for water treatment and distribution, minimizing leaks in water distribution systems is a goal of both public and private water distribution utilities. If a leak is not particularly conspicuous, it may go undetected for months at a time without repair. The detection and correction of anomalies in a water distribution system is therefore a permanent concern of the operators of such systems to mitigate the economic cost of water loss and damages. Moreover, the detection of leaks in a water distribution system is a key objective for limiting water consumption waste, which is of particular interest in regions subject to water stress, and in view of promoting sustainable development.

The detection of anomalies in a water distribution system is historically performed through human inspection and guesswork. Human inspection generally includes sending human operators to inspect pipes of the system and identify leaks and other anomalies. This detection can be aided for example using audio sensors, which detect noise due to a leak. However, the typically large size of water distribution systems renders human detection of leaks and anomalies very difficult. For example, the water distribution system of a large city comprises thousands of miles of pipes. It is therefore impossible to inspect all pipes frequently at a reasonable cost. Further, even when sensors are used, there may be too many sensors for a user to effectively monitor at once.

The sensors may also not always reliably producing accurate data. For example, the sensors may suffer mechanical or structural failure. The sensors may also experience digital/logic failure. The sensors may also not be reporting accurate data due to communication network issues. It is therefore helpful to prevent the detection of false alarms. A false alarm, for instance, may cause extraneous and costly maintenance activity or it may diminish the effectiveness of the detection system since operators may start to ignore leak warnings. There is therefore a need for a leak detection system that accurately detects leaks in a network of water pipes such as water mains and sub-mains.

In addition to leak detection challenges, water distribution systems may suffer from other monitoring, control, and administration issues associated with management of the distribution systems. The issues can lead to incorrect billing and time-consuming audit processes to validate data integrity. For example, historically service and work order scheduling has been performed manually, resulting in delayed service or repair of the identified anomalies. Also, management may be structured to include divisions that have historically been siloed from each other, e.g., water treatment plant management systems, consumer billing systems, service and repair systems, etc. Water distribution system management can also suffer from lack of adequate analysis and planning tools as well as manual, limited, and inefficient reporting of the status of the water distribution system as well as management metrics. Further, typically management systems lack the ability to concisely convey the real time operational health of the water distribution system. All of these issues can help attribute to billions of US dollars' worth of costs associated with operating water distribution systems worldwide.

### BRIEF DESCRIPTION OF THE DRAWINGS

Aspects of the disclosure are described with reference to the following figures, the features of which are not necessarily shown to scale. Some details of elements may not be shown or may be represented by conventional symbols in the interest of clarity and conciseness.

FIG. 1 is a schematic diagram of a water distribution system in accordance with one or more embodiments of the present disclosure.

FIG. 2 is a block diagram illustrating a network in accordance with one or more embodiments of the present disclosure.

FIG. 3 is an example graphical user interface of a management system in accordance with one or more embodiments of the present disclosure.

FIG. 4 is an example method of managing a water distribution system in accordance with one or more embodiments.

### DETAILED DESCRIPTION

The present disclosure describes improved systems and methods for management of a water distribution system. The system includes sensors operable to detect operational parameters of the components of the water distribution system. The system further includes a management system that includes a computing device including a storage media configured to receive information regarding the water distribution system from the sensors and a processor configured to process such information for management of the water distribution system. The management system may be used to analyze the water distribution system to determine operational parameters such as water usage and other analytics. The management system processes information related to the operation of the distribution system and its sensors in real time to detect anomalous water usage. In this manner, the management system overcomes issues with existing systems by being able to autonomously detect anomalies in the water distribution system and generate signals to control components to address or correct the issue causing the detected anomaly.

In addition, the management system processes the detected operational parameters by weighting the operational parameters based on at least one criterion to determine a single metric representing the operational status of the water distribution system. The management system may be used to display the single metric as a graphical image in a graphical user interface that allows a user to select the graphical image to display information relating to the operational parameters determining the single metric. In this manner, the water management system overcomes the limitations of existing systems by allowing a user to quickly and effectively ascertain the overall functional health of an entire water distribution system. Further, if additional information is desired by the user, the user may interact with the graphical user interface to reference additional information regarding the function health of the water distribution system.

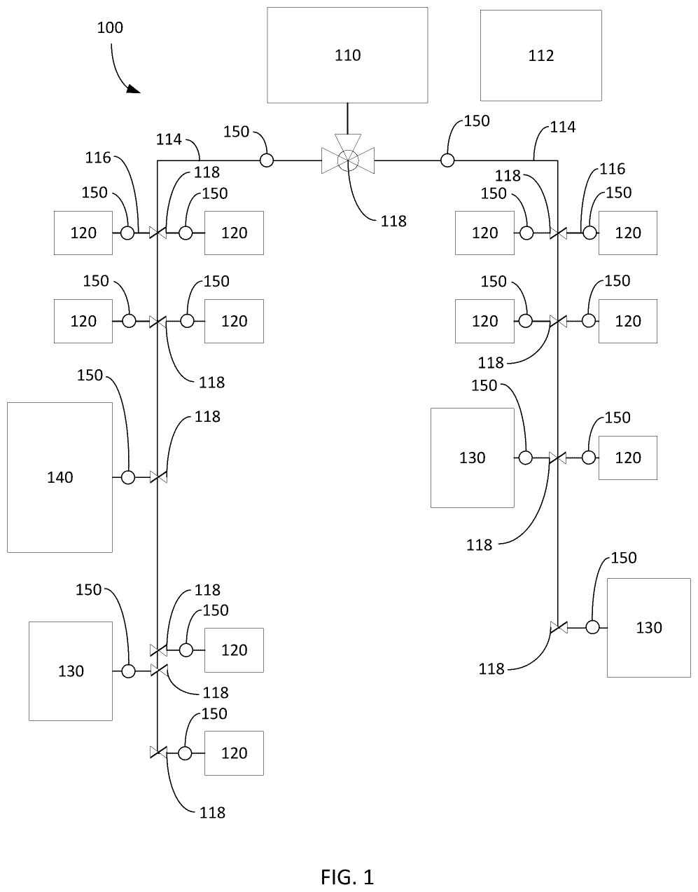

Turning now the figures, FIG. 1 shows an illustrative water distribution system 100 in accordance with one or more embodiments of the present disclosure that supplies water to an area such as a municipality, industrial park, commercial area, mixed use area, or development, and various other locations and environments. The water distribution system 100 may include a water treatment facility 110. Water is provided to the water treatment facility 110 from a water source (not depicted). The water treatment facility 110 treats the water that is provided from the water source such that it complies with legal, regulatory, and consumer requirements related to water content and quality. The water distribution system 100 also includes components such as water mains 114, water sub-mains 116, pumps (not shown), connectors (not shown), valves 118, fire hydrants (not shown), filters (not shown), tanks, water treatment equipment (such as at the water treatment facility 110), etc. The water that is provided by the water treatment facility 110 may be provided to water mains 114. The water mains 114 may distribute the water to consumers such as residential consumers 120, business consumers 130, and industrial consumers 140.

The water distribution system 100 also includes a management system 112 that includes a computing device including a storage media configured to receive information regarding the water distribution system 100 from sensors 150 and a processor configured to process such information for management of the water distribution system 100. The management system 112 may be a computing system at a specific location or may be remotely based and operate as an Internet based (“cloud based”) platform. The management system 112 may be used to analyze the water distribution system 100 to determine characteristics such as water usage and other analytics.

The management system 112 receives information from remote measurement devices that are located throughout the water distribution system 100, e.g., sensors 150, to ensure that water that is delivered to different locations throughout the water distribution system 100 complies with the legal, regulatory, and consumer requirements. Although the sensors 150 are shown in certain locations throughout the water distribution system 100, the sensors 150 may be placed at any location desirable for monitoring the operational parameters of the water distribution system 100, including being exposed to water flow in the distribution system 100. The sensors 150 detect and measure the operational parameters of the water distribution system 100 components, e.g., water mains, sub-mains, pumps, connectors, valves, fire hydrants, filters, tanks, water treatment equipment, etc. The sensors 150 may include suitable types of sensors operable to detect and measure operational parameters of the water distribution system 100, e.g., fluid volume, fluid flow rates, fluid pressure, water quality, chemical content, solid content, contamination, noise, vibrations, and any other suitable operational parameter throughout the water distribution system 100.

As an example, municipal piping systems may hold water pressures above several hundred pounds per square inch (psi) or hundreds of kilopascals (kPa). When a leak forms in a piping member, the leaking water produces vibrations as the water passes from inside the piping member to outside through the leak. Under the pressure of the municipal piping system, vibrations in the piping member can be of frequencies in the audible range and be of detectable amplitude, such as in a range from 0 Hz to 3000 Hz.

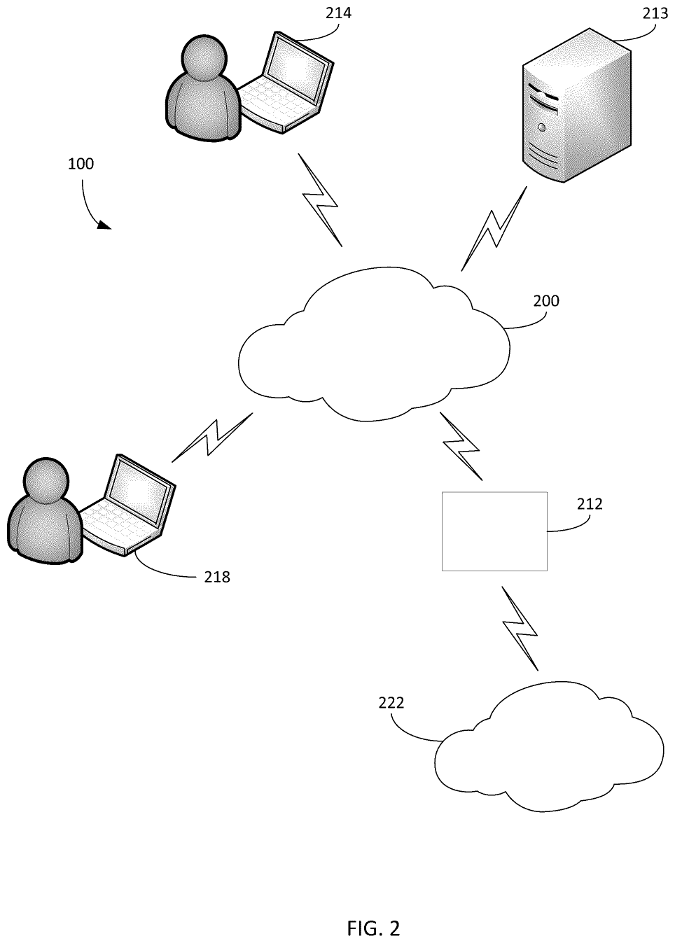

To establish communications between the sensors 150 and the management system 112, there may be wired or wireless communication connections between the sensors 150 may be and the management system 112. As shown in FIG. 2, the water distribution system 100 may also include a communication network 200. As shown in FIG. 2, the communication network 200 establishes wireless communications but may also be used for a wireless communications network. As shown the communication network 200 establishes communications between a server 213, an operator system 214, a client system 218, a management system 212, and a mesh network 222, for example. The management system 212 is configured to communicate with a plurality of “nodes” of the mesh network 222. The nodes may include sensors 150 such as leak detectors, consumer meter devices, relay devices, system status detecting devices, and other communication devices. The nodes are configured for communicating operational parameter information from the nodes or meter to the management system 212.

According to various implementations of the present disclosure, the management system 212 may be configured to receive information from sensors 150, which are connected within the mesh network, pertaining to operational parameters of the water distribution system 100. The sensors 150 may be configured to provide information related to various measurements, such as acoustic, pressure, or vibration measurements for example. This information may be stored by the management system 212 for historic purposes for determining a baseline indicative of a properly operating water distribution system 100. In this manner, when later signals are received that indicate anomalistic activity, the management system 212 may be configured to determine that a leak has been detected.

The server 213 may be configured to provide some of the leak detection analysis to assist the management system 212. The server 213 may also provide communication with other users via the communication network 200. In some embodiments, the server 213 may be part of a company responsible for managing the utility measurement data or for providing monitoring services for communicating issues (e.g., leaky pipes) in the utility infrastructure to the various utility companies. The communication network 200 may be a local area network (LAN), wide area network (WAN), such as the Internet, or any other suitable data communication networks. The communication network 200 may also include other types of networks, such as plain old telephone service (POTS), cellular systems, satellite systems, etc.

The operator system 214 shown in FIG. 2 may represent a computer system that is operated by personnel of a company managing the leak detection systems and utility measurement devices within the mesh network 222. In some respects, the operator system 214 may include an administrator for the management system 212. In some circumstances, as described in more detail below, the user of the operator system 214 may be provided with information indicating that an anomaly event has occurred that requires immediate response. For example, if a large leak, or burst event, has occurred in one of the water mains, resulting in a large amount of water escaping from the mains, the user of the operator system 214 may need to deploy maintenance or repair personnel to resolve the burst issues. The server 213 and/or the management system 212 may detect anomaly events, such as a burst in a pipe, and provide an alarm to the operator system 214. The alarm may be in the form of an automated e-mail, a pop-up window, an interrupt signal or indication on a computer of the operator system 214, or another suitable message signifying an urgent event.

The client system 218 may include a computer system used by a third-party provider. In this respect, the client system 218 may be a client of an administration company that manages the utility measurement data and/or provides monitoring services regarding the status of the utility infrastructure. The client system 218, therefore, may be able to receive and to review status updates regarding the infrastructure. Alarms may be provided to the client system 218, which may then be acknowledged and confirmed. The client system 218 may also receive historic data and manage the consumers' accounts and usage information. Note that the operator and the client may be in the same company and therefore the client system 218 may not be included in the water distribution system.

The management system 112 is used to create and display a visual representation of a digital model, or “digital twin”, of the water distribution system 100, including the type, location, configuration, and/or operational status of all the components and sensors 150 of the water distribution system 100. The management system 112 may then use a machine learning engine to process information related to the operation of the water distribution 110 system and its sensors 150 in real time. For example, machine learning algorithms and modes such as long short-term memory (“LSTM”), open-source models such as the META OPEN SOURCE® model PROPHET, as well as other appropriate models and algorithms. Such monitoring may be used to detect anomalies such as anomalous water usage in real time. To do so, the management system 112 communicating with the sensors 150 may include receiving operational parameter measurements from the water distribution system 100. The operational parameter measurement data may then be processed by the management system 112 to identify locations where there is an anomaly in the system, such as for example an unexpected loss of pressure within the water distribution system 100. Based on this information, the management system 112 may pinpoint the location where an inspection or repair needs to be made quickly and accurately based on the location of the sensor or sensors 150 that are detecting the anomaly or through measurements of the sensors 150 detecting a location. In a similar manner, the management system 112 may monitor characteristics of the water, such as material or chemical content, at different locations throughout the water distribution system 100. Based on these characteristics, the management system 112 may identify a location where an anomaly is occurring, such as for example where water quality does not comply with legal, regulatory, or consumer requirements. In addition, the management system 112 may monitor aspects of the water distribution system 100 over time, for example, to determine usage patterns or other changes to the water distribution system 100.

In response to detection of an anomaly such as a leak, the management system 112 may also be configured to automatically control or adjust a component or components of the water distribution system to mitigate water loss from leaks. For example, the management system may automatically close a valve or valves 118 so that water flow to certain portions of the distribution system 100 is stopped or rerouted. The management system 112 can also be configured to automatically produce alerts and report detected issues and automatically implement service and work orders to dispatch service personnel to service or repair problems in an efficient manner. Based on this information, the management system 112 may also suggest corrective action such as needed repairs at a location of the water distribution system 100.

As part of the monitoring by the management system 112, either in response to the detection of an anomaly or as part of routine monitoring, the management system 112 may also determine the operational health of the sensors 150 to validate the operational parameter data being received from the sensors 150. Such determination may include determining the communication status with the sensors 150, determining the power or battery level for the sensors 150, and comparing the current measurements with historical measurements for the sensors 150, including sensors 150 that are adjacent to each other. Such determination may also involve comparison with known properties for the types of sensors. Such comparison may be performed by the management system 112 using machine learning using algorithms as discussed above. The management system 112 may record the operational health of the sensors 150 and store the information over time for later use.

The management system 112 is not limited to leak detection and may also use machine learning for anomaly detection to identify other unusual water consumption of consumers. Such unusual water consumption may be due to, e.g., a faulty water meter, fraudulent tampering with a water meter, or sensor malfunction. As part of this detection functionality, the management system 112 may analyze water usage data of a water meter to determine the operational functionality of the water meter and determine a health or confidence rating for each water meter in the system using machine learning.

In addition, the management system also can integrate electrical usage and water treatment plant supervisory control and data acquisition (SCADA) systems to correlate performance of the water distribution system 100 with electrical usage and operations of the water treatment facility 110.

In addition, the management system 112 processes the detected operational parameters by weighting the operational parameters based on at least one criterion to determine a single metric representing the operational status of the water distribution system. For example, the criterion may be how the operational parameters reflect the possibility of a failure of the distribution system 100, such as a major leak. Under such a criterion, measured water pressure well as measured vibration and noise may be weighted higher than water quality or contamination, for example. Further, indications of a leak in a water main may be weighted more than indications of a leak at a sub-main or a consumer location. If the measured operational parameters are within acceptable ranges, the single metric may indicate that the water distribution system 100 is in good operational health. However, not all operational parameters need to be within acceptable ranges for the single metric to indicate good operational health. The management system 112 may be customized based on the acceptable operational conditions of the distribution system 100 to determine the criteria for what status of the water distribution system 100 is determined based on the measured operational parameters.

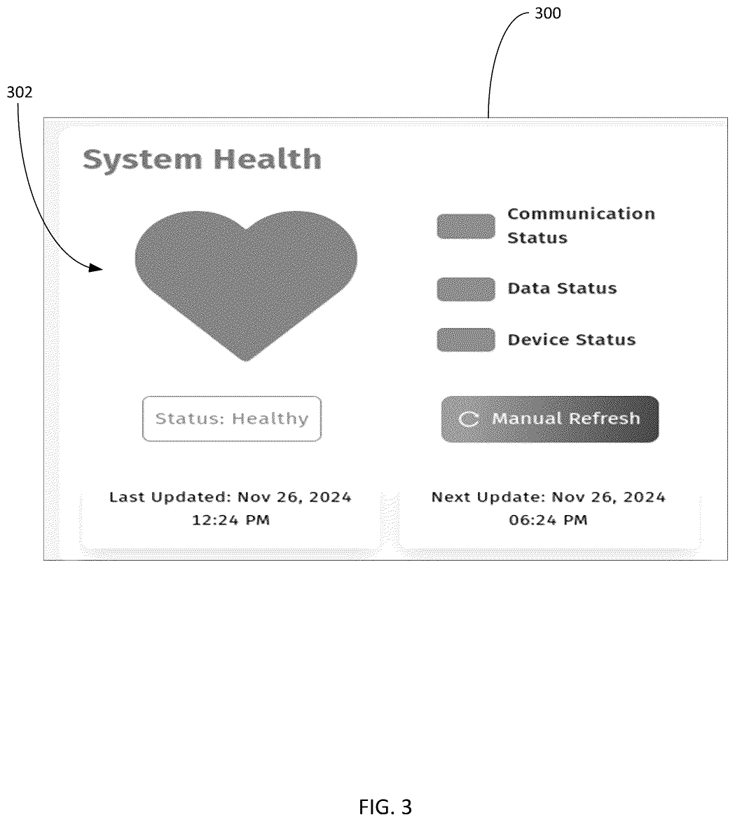

For displaying the metric as well as other graphical information depicting the water distribution system 100, operational parameters of the sensors 150, and alerts, the management system includes a display. As shown in FIG. 3, the management system 112 displays the single metric as a graphical image 302 on the display in a graphical user interface 300. The single metric allows a user to quickly and efficiently understand the overall functional health of the entire water distribution system 100. The graphical image 302 may also allow a user to select the graphical image 302 to display information relating to the operational parameters determining the single metric. For example, if the single metric indicates less than a minimum threshold of overall operational health, a user may select the graphical image 302 to display the sensors or operational parameters that are specifically causing issues or what anomaly is being detected. Thus, not only may the single metric be shown on the display, but the management system 112 may also display the health of individual components of the water distribution system 100. The single metric may also be displayed in any number of colors and shapes to further reflect the state of the water distribution system. Being able to visualize the health of the entire water distribution system in a single metric also enables the management system to monitor the metric over time and use machine learning to automatically improve performance and reliability.

The management system 112 may also show other selected performance analytics as well as water consumption trends over time. Further, the management system 112 may process the information from the sensors 150 to forecast operational parameters and make predictions such as anticipated water usage. Such forecasts may also provide information for the planning of future capacity buildout of the water distribution system 100 based on usage growth trends detected by the sensors 150. These forecasts may also be generated in reports by the management system 112 that are distributed or displayed for users.

Management of the water distribution system 100 also includes the operator collecting water usage fees from consumers. To assist operators, the management system 112 may also be configured to analyze usage data and automatically create and send invoices for the usage to consumers. Such invoices may be generated and transmitted to consumers electronically. Additionally, consumers may set up payment methods with the management system 112 such that the invoices may be paid automatically.

The management system 112 may also operate to monitor and control the water treatment plant 110 based on detected or forecasted water usage. Further, the management system 112 may also be configured to detect anomalous operational parameters of water treatment plant equipment and coordinate service and repair operations similar to leak detection described above.

The management system 112 also includes reporting functionality to the end consumer in real time. In this manner, the consumers may monitor their own water consumption over time and potentially determine additional ways to conserve water usage based on real time water usage data. Consumers may also be alerted as to a water leak on their property or a contamination of their water in real time using an electronic message or alert to an email or mobile application on a consumer mobile device. As part of this reporting functionality, the management system may automatically report the determined health or confidence rating for each water meter to the consumer. Such reporting may be done, for example, in real time or with each invoice sent to the consumer. This reporting helps gives the consumer a sense of confidence that the water meter is accurately detecting the consumer's water usage.

As mentioned above, the management system 112 includes a software component that may be installed on a local computing device or may be accessed using a website on the Internet. The software component is designed to be a modular system that includes applicant programming interfaces (APIs) for integration of one or more of the modules into other software platforms. The management system 112 may include modules for different functionalities such as billing, learning/forecasting, accounting, finance, and data visualization. The management system 112 may be configured for integrations for condition monitoring, preventive maintenance, repair, service and work order scheduling, and water quality monitoring and treatment, billing, end consumer interface. The management system 112 also includes financial reporting capability with integration with the accounting and finance modules.

Overall, the water management system 112 uses real time monitoring and machine learning engines to monitor and control the operation of the water distribution system 100 in a time and cost-efficient manner that ultimately lowers provide and consumer costs by reducing water loss. The management system 112 includes a model, or “digital twin”, of a water distribution system and provides performance metrics, trends, and analytics of the water distribution system 100. The management system 112 may be implemented as a software-as-a-service (SaaS) platform for water accountability and water treatment facility management. The management system 112 also integrates artificial intelligence (AI)/machine learning (ML) modules to learn patterns, flag anomalous usage, and predict trends. In this manner, the management system 112 gives operators the planning, forecasting, and financial tools to efficiently operate water distribution systems while reducing operating costs. The management system 112 also gives operators easy to understand visualization tools that can be integrated with billing to help consumers better understand their water consumption.

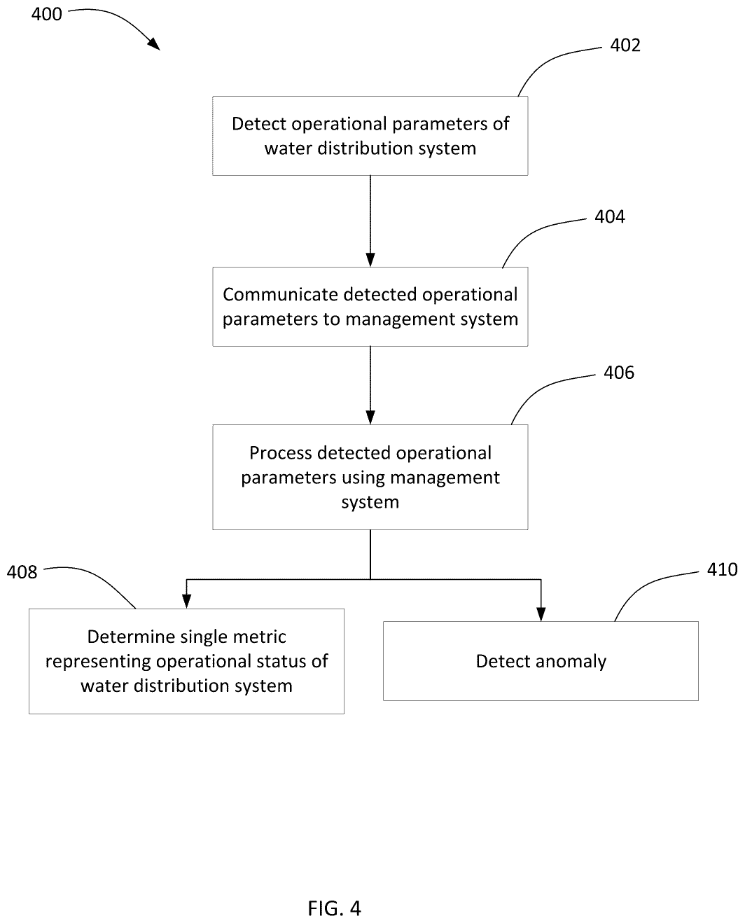

FIG. 4 is an example method 400 of managing a water distribution system such as the water distribution system in accordance with one or more embodiments. As shown in FIG. 4, the method 400 includes detecting operational parameters of the water distribution system using sensors at 402. The method 400 further includes communicating the detected operational parameters to a management system comprising a processor at 404. At 406, the method 400 further includes processing the detected operational parameters using the management system by weighting the operational parameters based on at least one criterion. At 408, the operational parameters are processed to determine a single metric representing the operational status of the water distribution system. As part of doing so, the management system may verify the reliability of the detected operational parameters received by evaluating the communication status of a communications network connecting all the sensors. The management system may also evaluate the data status with respect to factors such as recency and continuity of the data being received from the sensors. The management system may also evaluate the device status of all the monitored devices and monitoring equipment of the distribution system to determine whether any devices are not operating properly or are in a state other than an expected operational state. The management system may combine the evaluations of these three statuses to produce the single metric representing the operational status of the water distribution system. The management system may also include a machine learning engine that processes each of these evaluations over time to compose a more accurate single metric and provide information regarding predicting when the single metric may represent an unacceptable operational status of the water distribution system in the future. At 410, the operational parameters are also processed to detect an anomaly such as anomalous water usage. For example, the operational parameters may be processed using machine learning to detect the anomaly.

It should also be appreciated that the receiving, processing, and evaluation of data to produce a single operational metric is not limited to water distribution systems and instead may be used in any other type of system that includes the use of sensors to detect and communicate operational data of system components.

Certain terms are used throughout the description and claims to refer to particular features or components. As one skilled in the art will appreciate, different persons may refer to the same feature or component by different names. This document does not intend to distinguish between components or features that differ in name but not function.

For the embodiments and examples above, a non-transitory computer-readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of information. Such a user interface can be operated in conjunction with the communications unit and the bus. Various components of the system can be integrated such that processing identical to or similar to the processing schemes discussed with respect to various embodiments herein can be performed.

While descriptions herein may relate to “comprising” various components or steps, the descriptions can also “consist essentially of” or “consist of” the various components and steps.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A method of managing a water distribution system comprising:
detecting operational parameters of components of the water distribution system using sensors;
communicating the detected operational parameters to a management system comprising a processor;
processing the detected operational parameters using the management system by weighting the operational parameters based on at least one criterion to determine a single metric representing an operational status of the water distribution system; and
displaying, using the management system, the single metric as a graphical image in a graphical user interface that allows a user to select the graphical image to display information relating to the operational parameters determining the single metric.

2. The method of claim 1, wherein processing the detected operational parameters further comprises processing the detected operational parameters to detect an anomaly in the system.

3. The method of claim 2, wherein the anomaly comprises at least one of a leak, a blockage, a contamination, or unusual water consumption in the system.

4. The method of claim 2, further comprising using the management system to control a component of the water distribution system in response to the detection of the anomaly.

5. The method of claim 2, further comprising using the management system to create and display a visual representation of a model of the distribution system, including a location of the anomaly.

6. The method of claim 1, wherein processing the detected operational parameters further comprises processing the detected parameters using machine learning to predict an anomaly in the operation of the system.

7. The method of claim 1, further comprising communicating the detected operational parameters to the management system using a wireless communication network.

8. The method of claim 1, further comprising:
using the sensors to detect water usage in the distribution system over time;
communicating the detected water usage to the management system; and
processing the detected water usage over time using the management system to predict anticipated usage in the future.

9. The method of claim 1, wherein processing the detected operational parameters using the management system further comprises validating the detected operational parameters of one of the sensors by comparing the detected operational parameters with historical detected operational parameters from the sensor as well as historical detected operational parameters of other sensors.

10. A water distribution system comprising:
components configured to transport water throughout the system;
sensors operable to detect operational parameters of the components; and
a management system comprising a processor configured to:
receive the detected operational parameters from the sensors;
process the detected operational parameters by weighting the operational parameters based on at least one criterion to determine a single metric representing an operational status of the water distribution system; and
display the single metric as a graphical image in a graphical user interface that allows a user to select the graphical image to display information relating to the operational parameters determining the single metric.

11. The system of claim 10, wherein the management system is further configured to process the detected operational parameters to detect an anomaly in the system.

12. The system of claim 11, wherein the anomaly comprises at least one of a leak, a blockage, a contamination, or unusual water consumption in the system.

13. The system of claim 11, wherein the management system is further configured to control at least one of the components in response to the detection of the anomaly.

14. The system of claim 10, wherein the management system is further configured to create and display a visual representation of a model of the distribution system, including a location of the anomaly.

15. The system of claim 10, wherein the management system is configured to process the detected parameters using machine learning to predict an anomaly in the operation of the system.

16. The system of claim 10, wherein the management system is configured to receive the detected operational parameters from the sensors through a wireless communication network.

17. The system of claim 10, wherein the processor is further configured to process the detected operational parameters by validating the detected operational parameters of one of the sensors by comparing the detected operational parameters with historical detected operational parameters from the sensor as well as historical detected operational parameters of other sensors.

18. A non-transitory computer-readable medium storing instructions that, when executed by a processor, cause the processor to perform a method comprising:
receiving operational parameters of components of a water distribution system detected by sensors;
processing the detected operational parameters by weighting the operational parameters based on at least one criterion to determine a single metric representing an operational status of the water distribution system; and
displaying the single metric as a graphical image in a graphical user interface that allows a user to select the graphical image to display information relating to the operational parameters determining the single metric.

19. The non-transitory computer-readable medium of claim 18, wherein processing the detected operational parameters further comprises processing the detected operational parameters to detect an anomaly in the system.

20. The non-transitory computer-readable medium of claim 19, the method further comprising controlling a component of the water distribution system in response to the detection of the anomaly.
